(19) United States
(12) Patent Application Publication
(10) Pub. No.: US 2020/0250592 A1
(43) Pub. Date: Aug. 6, 2020

(54) ROUTE PLANNING USING PARKING RESERVATIONS

(71) Applicant: United Parcel Service of America, Inc., Atlanta, GA (US)

(72) Inventor: Juan Perez, Milton, GA (US)

(21) Appl. No.: 16/855,152

(22) Filed: Apr. 22, 2020

Related U.S. Application Data
(63) Continuation-in-part of application No. 14/639,216, filed on Mar. 5, 2015.
(60) Provisional application No. 61/948,284, filed on Mar. 5, 2014.

(51) Int. Cl. G06Q 10/02; G08G 1/14; G08G 1/00; G01C 21/34; G06Q 10/08; H04W 4/40

(52) U.S. Cl. CPC G06Q 10/02; G08G 1/146; G08G 1/143; H04W 4/40; G01C 21/3407; G06Q 10/08355; G08G 1/202

(57) ABSTRACT

Embodiments of the present invention provide methods, systems, apparatuses, and computer program products for planning or updating a delivery route based at least in part on a parking reservation and/or projected parking availability. One embodiment provides a method for planning a delivery route comprising storing stop locations in association with parking information, wherein the parking information associated with a stop location indicates if a parking reservation should be requested for the stop location; identifying a stop location based at least in part on a delivery location associated with an item to be delivered to the delivery location; determining whether the parking information associated with the identified stop location indicates that a parking reservation should be requested for the identified stop location; and responsive to determining that a parking reservation should be requested for the identified stop location, generating a parking reservation request for use during the delivery of the item.

### CROSS-REFERENCE TO RELATED APPLICATIONS

The present application is a continuation-in-part of co-pending U.S. Non-provisional patent application Ser. No. 14/639,216, entitled “Route Planning Using Parking Reservations” and filed on Mar. 5, 2015, which claims the benefit of and priority to U.S. Provisional Patent Application No. 61/948,284, filed on Mar. 5, 2014, which are each incorporated herein by reference in their entirety.

### BACKGROUND

In some areas, (e.g., urban or metropolitan areas) it is often difficult to find parking. If a delivery vehicle driver cannot find parking near a delivery location, it may be difficult for the driver to efficiently deliver an item to the delivery location. If a parking place near the delivery location is not available, the delivery vehicle driver may park illegally in order to deliver the item, which may result in the delivery vehicle receiving a parking ticket. In other instances, the delivery vehicle driver may be forced to park far away from the delivery location in order to deliver the item, which may result in the delivery vehicle driver needing to walk a long distance while carrying the item. This issue may be compounded if the delivery vehicle driver is delivery more than one item to the delivery location and the delivery vehicle driver must make more than one trip from the delivery vehicle to the delivery location. Thus, if parking is not available near a delivery location, the delivery vehicle driver may not be able to efficiently deliver an item (or multiple items) to the delivery location.

Therefore, there is a need for methods, systems, apparatuses, and computer program products to improve the efficiency of item delivery in areas where finding parking tends to be difficult.

### BRIEF SUMMARY

Embodiments discussed hereinafter include a centralized route planning system that communicates seamlessly with a parking reservation system and a parking reservation location database, and which provides an improvement in the technical field of computerized routing technologies. In embodiments, the centralized route planning system may generate and place selected parking reservations based on querying the parking reservation location database for flagged locations, wherein the parking reservation location may store historical or predicted parking availability information for various parking locations. The centralized route planning system may then, in various embodiments, generate and electronically push optimized vehicle routes and parking reservation confirmations out to an entire fleet of delivery vehicles. In embodiments, the centralized route planning systems facilitates optimizing routes on a global scale, at least on a daily basis, and this can involve any number of different time zones, millions of distinct locations across the world, and hundreds of thousands of individual vehicles. These aspects are not performed or found in other computerized routing technologies, and as such, these aspects are not conventional. Further, the centralized route planning system cannot be performed in the human mind due both to the scale involved and the computer-specific functions discussed hereinafter, with regard to embodiments.

Embodiments of the present invention provide methods, systems, apparatuses, and computer program products for planning or updating a delivery route based at least in part on a parking reservation and/or projected parking availability. In one aspect of the present invention, a method for using a parking reservation to deliver an item is provided. In various embodiments, the method comprises (a) storing a plurality of stop locations in association with parking information, wherein the parking information associated with a stop location indicates if a parking reservation should be requested for the stop location; (b) identifying a stop location based at least in part on a delivery location associated with an item, wherein the item is to be delivered to the delivery location; (c) determining whether the parking information associated with the identified stop location indicates that a parking reservation should be requested for the identified stop location; and (d) responsive to determining that a parking reservation should be requested for the identified stop location, generating a parking reservation request for a parking place for use during the delivery of the item to the delivery location.

In another aspect of the present invention, a system for using a parking reservation to deliver an item is provided. In various embodiments, the system comprises at least one processor and at least one memory including program code. The at least one memory and the program code configured to, with the processor, cause the system to at least (a) store a plurality of stop locations in association with parking information, wherein the parking information indicates if a parking reservation should be requested for the stop location; (b) identify a stop location based at least in part on a delivery location associated with an item, wherein the item is to be delivered to the delivery location; (c) determine whether parking information associated with the identified stop location indicates that a parking reservation should be requested for the identified stop location; and (d) responsive to determining that a parking reservation should be requested for the identified stop location, generate a parking reservation request for a parking place for use during the delivery of the item to the delivery location.

In yet another aspect of the present invention, a non-transitory computer program product is provided. In various embodiments, the non-transitory computer program product comprises at least one computer-readable storage medium having computer-readable program code portions embodied therein. The computer-readable portions comprise (a) an executable portion configured to store a plurality of stop locations in association with parking information, wherein the parking information indicates if a parking reservation should be requested for the stop location; (b) an executable portion configured to identify a stop location based at least in part on a delivery location associated with an item, wherein the item is to be delivered to the delivery location; (c) an executable portion configured to determine whether parking information associated with the identified stop location indicates that a parking reservation should be requested for the identified stop location; and (d) an executable portion configured to responsive to determining that a parking reservation should be requested for the identified stop location, generate a parking reservation request for a parking place for use during the delivery of the item to the delivery location.

In still another aspect of the present invention, a method for planning a delivery route is provided. In various embodiments, the method comprises (a) identifying one or more delivery locations, wherein at least one item is to be delivered to each of the one or more delivery locations during execution of the delivery route; (b) generating a request for at least one parking reservation, the parking reservation associated with at least one delivery location; (c) receiving a confirmation of at least one parking reservation, wherein the confirmation comprises parking reservation information; and (d) planning at least one delivery route based at least in part on at least a portion of the parking reservation information.

In another aspect of the present invention, a system for planning a delivery route is provided. In various embodiments, the system comprises at least one processor and at least one memory including program code. The at least one memory and the program code configured to, with the processor, cause the system to at least (a) identify one or more delivery locations, wherein at least one item is to be delivered to each of the one or more delivery locations during execution of the delivery route; (b) generate a request for at least one parking reservation, the parking reservation associated with at least one delivery location; (c) receive a confirmation of at least one parking reservation, wherein the confirmation comprises parking reservation information; and (d) plan at least one delivery route based at least in part on at least a portion of the parking reservation information.

In yet another aspect of the present invention, a non-transitory computer program product is provided. The non-transitory computer program product comprises at least one computer-readable storage medium having computer-readable program code portions embodied therein. The computer-readable portions comprise (a) an executable portion configured to identify one or more delivery locations, wherein at least one item is to be delivered to each of the one or more delivery locations during execution of the delivery route; (b) an executable portion configured to generate a request for at least one parking reservation, the parking reservation associated with at least one delivery location; (c) an executable portion configured to receive a confirmation of at least one parking reservation, wherein the confirmation comprises parking reservation information; and (d) an executable portion configured to plan at least one delivery route based at least in part on at least a portion of the parking reservation information.

In still another aspect of the present invention, a method for dynamically planning a delivery route is provided. In various embodiments, the method comprises (a) generating a request for a parking reservation based at least in part on a current location of a delivery vehicle, the request comprising reservation information; (b) planning a delivery route based at least in part on at least a portion of the reservation information and the current location of the delivery vehicle; and (c) providing the delivery route to a delivery route driver.

In another aspect of the present invention, a system for dynamically planning a delivery route is provided. In various embodiments, the system comprises at least one processor and at least one memory including program code. The at least one memory and the program code configured to, with the processor, cause the system to at least (a) generate a request for a parking reservation based at least in part on a current location of a delivery vehicle, the request comprising reservation information; (b) plan a delivery route based at least in part on at least a portion of the reservation information and the current location of the delivery vehicle; and (c) provide the delivery route to a delivery route driver.

In yet another aspect of the present invention, a non-transitory computer program product is provided. In various embodiments, the non-transitory computer program product comprises at least one computer-readable storage medium having computer-readable program code portions embodied therein. The computer-readable portions comprises (a) an executable portion configured to generate a request for a parking reservation based at least in part on a current location of a delivery vehicle, the request comprising reservation information; (b) an executable portion configured to plan a delivery route based at least in part on at least a portion of the reservation information and the current location of the delivery vehicle; and (c) an executable portion configured to provide the delivery route to a delivery route driver.

In still another aspect of the present invention, a method for planning a delivery route is provided. In various embodiments, the method comprises (a) identifying one or more delivery locations, wherein at least one item is to be delivered to each of the one or more delivery locations during execution of the delivery route; (b) for at least one of the one or more delivery locations, determining a projected parking availability for parking within a predefined geographical area around the delivery location; and (c) planning a delivery route based at least in part on the projected parking availability.

In another aspect of the present invention, a system for planning a delivery route is provided. In various embodiments, the system comprises at least one processor and at least one memory including program code. The at least one memory and the program code configured to, with the processor, cause the system to at least (a) identify one or more delivery locations, wherein at least one item is to be delivered to each of the one or more delivery locations during execution of the delivery route; (b) for at least one of the one or more delivery locations, determine a projected parking availability for parking within a predefined geographical area around the delivery location; and (c) plan a delivery route based at least in part on the projected parking availability.

In yet another aspect of the present invention, a non-transitory computer program product is provided. In various embodiments, the non-transitory computer program product comprises at least one computer-readable storage medium having computer-readable program code portions embodied therein. the computer-readable portions comprises (a) an executable portion configured to identify one or more delivery locations, wherein at least one item is to be delivered to each of the one or more delivery locations during execution of the delivery route; (b) an executable portion configured to for at least one of the one or more delivery locations, determine a projected parking availability for parking within a predefined geographical area around the delivery location; and (c) an executable portion configured to plan a delivery route based at least in part on the projected parking availability.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a system for planning a delivery route around a parking reservation, in accordance with the present invention;

FIG. 2 is a schematic diagram of a driver computing device that may be used by a delivery vehicle driver, in accordance with various embodiments of the present invention;

FIG. 3 is a schematic diagram of a route planning system, in accordance with various embodiments of the present invention;

FIG. 4 is a flowchart illustrating a method for planning a delivery route using a parking reservation, in accordance with various embodiments of the present invention; and

FIG. 5 is a flowchart illustrating a method of dynamically planning a delivery route using a parking reservation, in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

### General Overview

A typical item delivery service involves stopping at various locations on a route within a certain service area and providing services at each stop. Each service stop may involve delivery of one or more items and/or involve picking up one or more items. Each service stop (also referenced as a “stop) is typically planned as one of a sequence of stops along a predetermined delivery route. The delivery route is typically determined based on the items to be delivered (deliveries), items to be picked up (pick-ups), or both. The sequence of stops along the route is called herein a dispatch plan. The sequence can be presented to the delivery vehicle driver in tabular or graphical form. The dispatch plan is typically provided to the delivery vehicle driver, either in a paper format or electronically communicated to a driver computing device, which can be accessed as needed by the driver. To facilitate understanding of various embodiments of the invention herein, we will refer to delivering an item, though the concepts of the present invention are equally applicable to picking-up an item. Of course, applications involving other services other than item delivery are possible and the principles of the present invention can be readily adapted for such.

As noted above, at various delivery locations (e.g., in urban or metropolitan areas or the like), it may be difficult to find a legal and/or a nearby parking place where the delivery vehicle may be parked while the delivery vehicle driver completes the delivery. A lack of available legal and/or nearby parking places in the vicinity of a delivery location may force the driver to park the delivery vehicle illegally, which can result in a parking ticket, or alternatively park a substantial distance from the delivery stop, which may reduce the efficiency with which the delivery may be made. Additionally, time and fuel may be wasted if the delivery vehicle driver must search the area near a delivery location for an available legal and/or nearby parking place.

Various embodiments of the present invention provide methods, apparatus, systems, and computer program products that may improve the efficiency of completing an item delivery. In particular, a parking reservation may be acquired to ensure a delivery vehicle driver will have a legal and/or nearby place to park the delivery vehicle while making one or more deliveries (and/or pick-ups) on the driver's delivery route. The information regarding the parking reservation may be incorporated into planning and/or optimizing the delivery route. For example, the parking reservation may be used as a constraint for planning and/or optimizing the delivery route. Thus, the delivery vehicle driver may more efficiently deliver an item to the delivery location where nearby parking tends to be difficult to find while completing a delivery route that has been optimized around the parking reservation. In other embodiments, the system may predict when parking will be available based on historical data and plan delivery routes/times accordingly.

### System Architecture

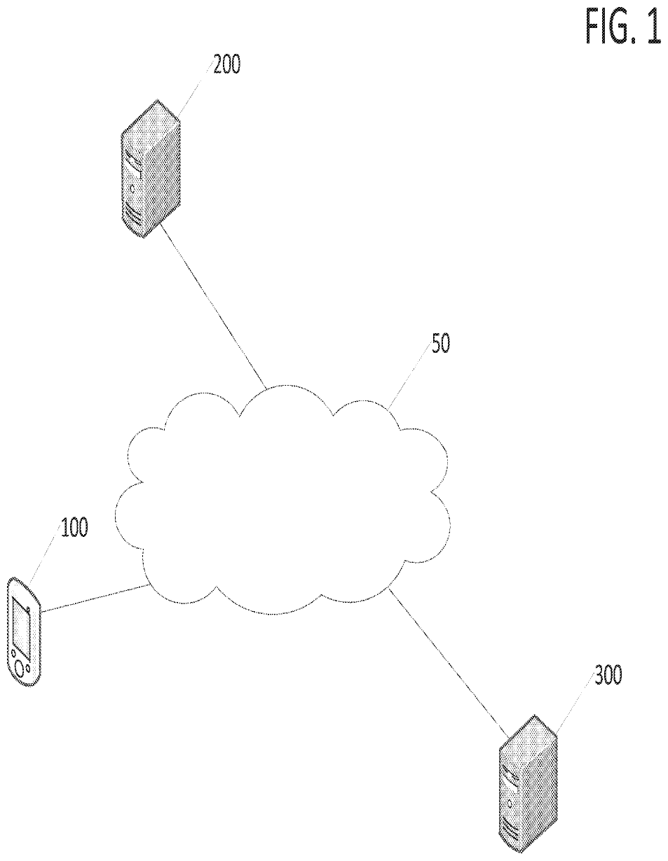

FIG. 1 illustrates one example embodiment of a system architecture that can be used in conjunction with various embodiments of the present invention. The illustrated system includes one or more driver computing devices 100, one or more route planning systems 200, and one or more parking registration systems 300. The one or more driver computing devices 100, the one or more route planning systems 200, and the one or more parking reservation systems 300 may communicate via the same or different wireless or wired networks 50 including, for example, a wired or wireless Personal Area Network (PAN), Local Area Network (LAN), Metropolitan Area Network (MAN), Wide Area Network (WAN), or the like.

In various embodiments, the driver computing device 100 or the route planning system 200 may request a parking reservation from the parking reservation system 300. The requested parking reservation may be configured to facilitate delivery of an item to a delivery location where finding nearby parking (without the use of a parking reservation) may be difficult. The parking reservation information may then be used by the route planning system 200 to plan and/or optimize delivery routes for one or more delivery vehicles. Delivery route information may then be communicated to a delivery vehicle driver via the driver's driver computing device 100. The delivery vehicle driver may then proceed with completing the delivery route, making use of any parking reservation planned into the delivery route.

In other embodiments, the driver computing device 100 or the route planning system 200 may request projected parking availability from the parking reservation system 300. The requested projected parking availability may be configured to facilitate delivery of an item to a delivery location where finding nearby parking (without the use of a parking reservation) may be difficult. The projected parking availability may then be used by the route planning system 200 to plan and/or optimize delivery routes for one or more delivery vehicles. Delivery route information may then be communicated to a delivery vehicle driver via the driver's driver computing device 100. The delivery vehicle driver may then proceed with completing the delivery route. In one embodiment, the route planning system 200 may store historical parking information (e.g., in a parking data database and/or the like) that may be used to predict parking availability and may request a projection of parking availability from a module and/or the like associated with the route planning system 200.

Various aspects of the one or more driver computing devices 100, the one or more route planning systems 200, and the one or more parking reservation systems 300 will now each be discussed in detail below herein.

### Driver Computing Device 100

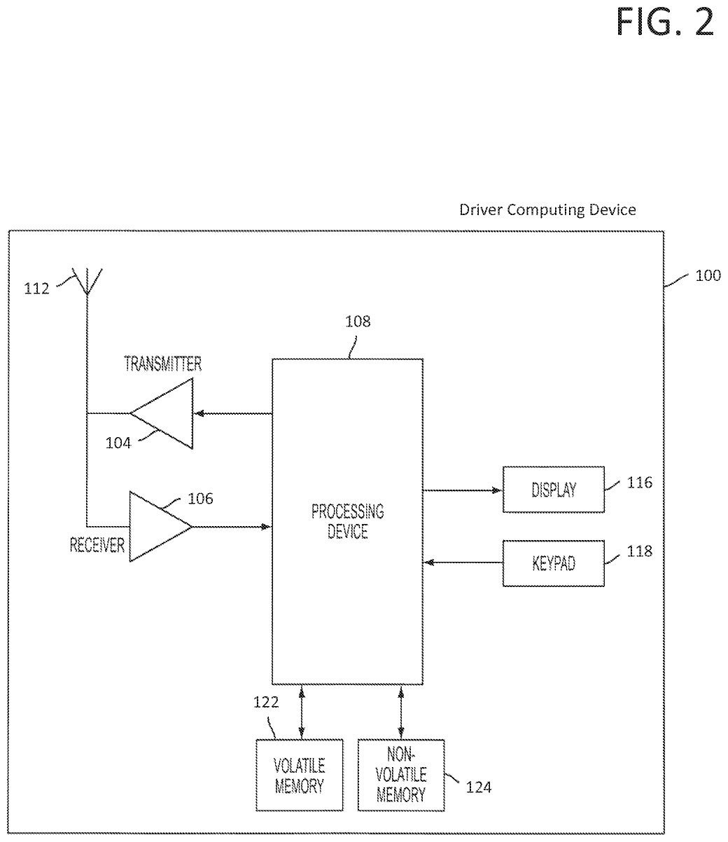

FIG. 2 provides an illustrative schematic of an exemplary driver computing device 100 that may be used in connection with various embodiments of the present invention. In the embodiment shown in FIG. 2, the driver computing device 100 is a handheld computing device. In various embodiments, the driver computing device may be any handheld electronic device, such as a pocket PC, personal digital assistant (PDA), handheld computer, smartphone, portable media player, laptop, pager, converged device, handheld game console, personal navigation device, smart watch, other portable computing device, any heads-up display and/or wearable computer, and/or the like—including both wireless and wireline devices.

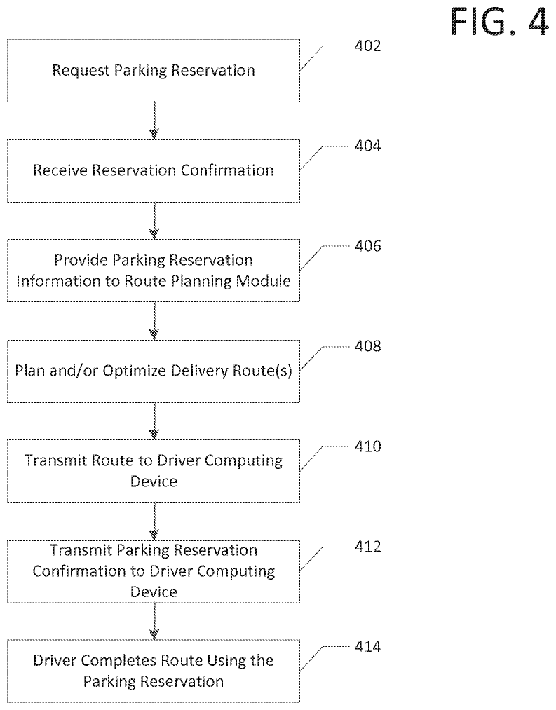

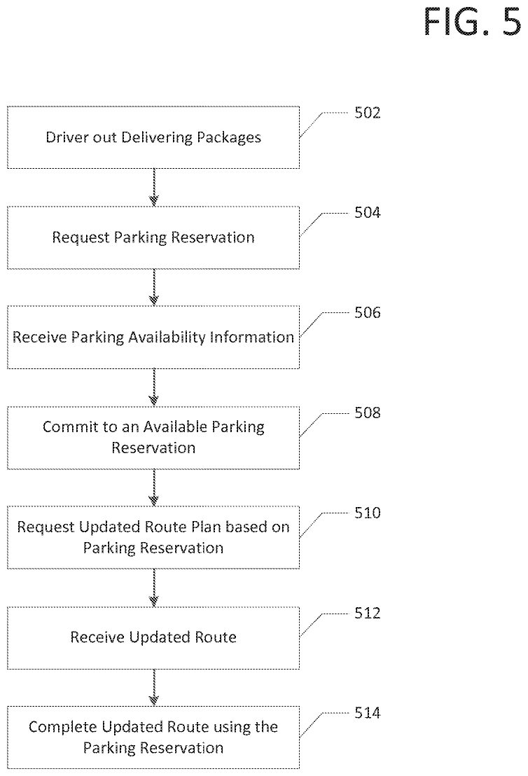

The driver computing device 100 shown in FIG. 2 includes an antenna 112, a transmitter 104, a receiver 106, and a processing device 108, e.g., a processor, controller, or the like, that provides signals to and receives signals from the transmitter 104 and receiver 106, respectively. The processing device 108 may be configured to perform various operations related to the methods described below with regard to FIGS. 4 and 5. For example, the processing device 108 may be configured to perform various operations related to requesting a parking reservation, communicating information regarding a parking reservation to the one or more route planning systems 200, receiving a delivery route from the one or more route planning systems 200, displaying the delivery route to the delivery vehicle driver, and/or the like.

The signals provided to and received from the transmitter 104 and the receiver 106, respectively, may include signaling information in accordance with an air interface standard of applicable wireless systems. In this regard, the driver computing device 100 may be capable of operating with one or more air interface standards, communication protocols, modulation types, and access types. More particularly, the driver computing device 100 may operate in accordance with any of a number of second-generation (2G) communication protocols, third-generation (3G) communication protocols, fourth-generation (4G) communication protocols and/or the like. Further, for example, the driver computing device 100 may operate in accordance with any of a number of different wireless networking techniques, including Bluetooth, IEEE 802.11 (Wi-Fi), 802.16 (WiMAX), ultra wideband (UWB), and/or the like. Via these communication standards and protocols, the driver computing device can communicate with the one or more route planning systems 200 and/or the one or more parking reservation systems 300. Additionally, the driver computing device 100 may use these communication standards and protocols to communicate with various entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The driver computing device 100 can also download changes, add-ons, and updates, for instance, to its firmware, software (e.g., including modules), and operating system. For example, the driver computing device 100 may be configured to operate a module similar to the parking reservation module 235 described herein as operating on the route planning system 200.

According to one embodiment, the driver computing device 100 may include a location determining device and/or functionality. For example, the driver computing device 100 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The driver computing device 100 may also comprise a user interface (that can include a display 116 coupled to a processing device 108) and/or a user input interface (coupled to the processing device 116). The user input interface can comprise any of a number of devices allowing the driver computing device 100 to receive data, such as a keypad 118, a touch display (not shown), barcode reader (not shown), radio frequency identification (RFID) tag reader (not shown), or other input device. In embodiments including a keypad 118, the keypad 118 can include the conventional numeric (0-9) and related keys (#, *), and other keys used for operating the driver computing device 100 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Although not shown, the driver computing device 100 may also include a battery, such as a vibrating battery pack, for powering the various circuits that are required to operate the driver computing device 100, as well as optionally providing mechanical vibration as a detectable output.

The driver computing device 100 can also include volatile memory 122 and/or non-volatile memory 124, which can be embedded and/or may be removable. For example, the non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the driver computing device 100 to implement the functions of the driver computing device 100. For example, the volatile and non-volatile memory can be used to temporarily or permanently store input from the one or more route planning systems 200 and/or input from the one or more parking reservation systems 300. The memory can also store content, such as computer program code for an application and/or other computer programs. For example, the memory may store computer program code for instructing the processing device 108 to perform operations discussed above and below with regard to FIGS. 4 and 5 to request a parking reservation, receive information related to a parking reservation, request an optimized delivery route, receiving a delivery route, and displaying the delivery route to the delivery vehicle driver.

### Route Planning System 200

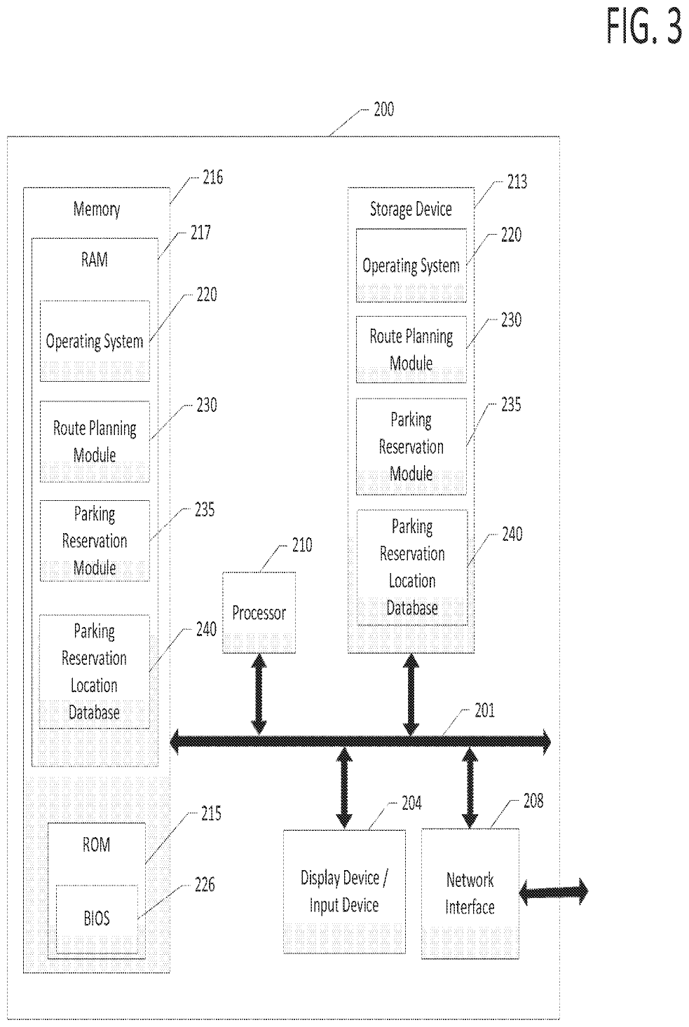

FIG. 3 provides a schematic diagram of an example route planning system 200 that may be used in connection with embodiments of the invention. In various embodiments relating to delivering an item, the route planning system 200 may be operated by and/or on behalf of a common carrier (e.g., United Parcel Service, United States Postal Service, etc.) In general, the term “system” may refer to, for example, one or more computers, computing entities, computing devices, mobile phones, gaming consoles (e.g., Xbox, Play Station, Wii), desktops, tablets, notebooks, laptops, wearable computing devices, distributed systems, servers or server networks, blades, gateways, switches, processing devices, processing entities, set-top boxes, relays, routers, network access points, base stations, the like, and/or any combination of devices or entities adapted to perform the functions, operations, and/or processes described herein. The illustrated route planning system 200 includes a processor 210, such as one or more processing elements, which may include complex programmable logic devices (CPLDs), microprocessors, multi-core processors, coprocessing entities, application-specific instruction-set processors (ASIPs), and/or controllers or other processing devices or circuitry. The term circuitry may refer to an entirely hardware embodiment or a combination of hardware and computer program products. Thus, the processor 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 210 may be configured for a particular use or configured to execute instructions stored in volatile or non-volatile media or otherwise accessible to the processor 210. As such, whether configured by hardware or computer program products, or by a combination thereof, the processor 210 may be capable of performing steps or operations according to embodiments of the present invention, such as the embodiments illustrated in FIGS. 4 and 5, when configured accordingly. The processor 210 is used to execute software instructions for carrying out the defined steps of the method of the various embodiments of the present invention. The processor 210 communicates using a data bus 201 that is used to convey data and program instructions, typically, between the processor and memory 216.

The route planning system 200 further includes memory 216, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. In various embodiments, memory 216 includes both read only memory (ROM) 215 and random access memory (RAM) 217. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the route planning module 230 and/or the parking reservation module 235. An example database that, in various embodiments, may be stored in memory 216 is a parking reservation location database 240 that comprises the locations where parking reservations may be requested. The term database, database instance, database management system, and/or similar terms used herein interchangeably may refer to a structured collection of records or data that is stored in a computer-readable storage medium, such as via a relational database, hierarchical database, and/or network database.

In at least one embodiment, the route planning system 200 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 210. Thus, the databases, database instances, database management systems, data, applications, programs, program modules, scripts, source code, object code, byte code, compiled code, interpreted code, machine code, executable instructions, and/or the like may be used to control certain aspects of the operation of the route planning system 200 with the assistance of the processor 210 and operating system 220, such as the route planning module 230 and/or the parking reservation module 235.

In various embodiments, memory 216 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 210 using an I/O bus instead of a dedicated bus 101. The memory 216 could also be secondary memory, such as disk storage, that stores a relatively large amount of data. The secondary memory may be a floppy disk, hard disk, compact disk, DVD, or any other type of mass storage type known to those skilled in the computer arts. The memory may also comprise any application program interface, system, libraries and any other data by the processor to carry out its functions. ROM 215 is used to store a basic input/output system 226 (BIOS), containing the basic routines that help to transfer information between components of the route planning system 200, including the route planning module 230, the parking reservation module 235, the parking reservation location database 240 and/or the operating system 220.

In addition, the route planning system 200 includes at least one storage device 213, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 213 is connected to the system bus 201 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 217. Such program modules include the operating system 220, the route planning module 230 and/or the parking reservation module 235. Those skilled in the art will appreciate that other modules may be present in RAM 217 to effectuate the various embodiments of the present invention. Furthermore, rather than program modules, the route planning module 230 and/or the parking reservation module 235 may comprise stand-alone computers connectively coupled to the route planning system 200.

Also located within the route planning system 200 is a network interface 208, for interfacing and communicating with other elements of a computer network, such as by communicating data, content, information, and/or similar terms used herein interchangeably that can be transmitted, received, operated on, processed, displayed, stored, and/or the like. For instance, the route planning system 200 may be in communication with one or more driver computing devices 100 and/or the parking reservation system 300. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the route planning system 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information may be input by a user to the route planning system 200 via the network interface 208 and/or input/output device 204. This input information may include information related to items to be delivered, information related to parking reservations that have been or may be requested or other information. This input information may vary, however, depending on the configuration and informational requirements of the route planning system 200.

As mentioned above, the route planning system 200 also includes an input/output device 204 for receiving and displaying data. The route planning system 200 may include or be in communication with one or more input elements, such as a keyboard input, a mouse input, a touch screen/display input, audio input, pointing device input, joystick input, keypad input, and/or the like, as indicated by input/output device 204. The route planning system 200 may also include or be in communication with one or more output elements, as indicated by input/output device 204, such as audio output, video output, screen/display output, motion output, movement output, and/or the like.

The route planning system 200 is configured to plan and/or optimize one or more delivery routes. The route planning system 200 may further be configured to request one or more parking reservations from the parking reservation system 300 and receive parking reservation information from the parking reservation system 300 and/or from one or more driver computing devices 100. The route planning system 200 may then plan and/or optimize the one or more delivery routes around the one or more parking reservations. Once a delivery route has been planned and/or optimized, the delivery route, and possibly information related to the parking reservation, may be communicated to the driver computing device 100.

Those skilled in the art will recognize that many other alternatives and architectures are possible and can be used to practice various embodiments of the invention. The embodiment illustrated in FIG. 3 can be modified in different ways or incorporated within a network and be within the scope of the invention. For example, one or more components of the route planning system 200 may be located remotely from other route planning system 200 components, such as in a distributed system. Furthermore, one or more of the components may be combined and additional components performing functions described herein may be included in the route planning system 200. Thus, the route planning system 200 can be adapted to accommodate a variety of needs and circumstances.

### Parking Reservation System 300

In various embodiments, the parking reservation system 300 may be operated by, on behalf of, and/or in association with a parking management company and/or the like. In one embodiment, the parking reservation system 300 may include one or more components that are functionally similar to those of the route planning system 200. For example, in one embodiment, the parking reservation system 300 may include one or more processing elements, one or more display device/input devices, volatile and non-volatile storage or memory, and/or one or more communications interfaces. The parking reservation system 300 may also comprise various other systems, such as a parking reservation database, a parking reservation claims system, a parking reservation payment system, and a variety of other systems and their corresponding components. In particular, the parking reservation system 300 may include components configured to receive a parking reservation request, store information regarding a parking reservation, transmit a parking reservation confirmation, validate a parking reservation claim, and transmit a parking reservation invoice, and/or the like. Parking reservation system 300 may be in communication with one or more driver computing devices 100, route planning system 200, and/or other computing devices.

### System Operation

As indicated above, various embodiments of the route planning system 200 may operate various modules (e.g., modules 230, 235). In various embodiments, various modules (e.g., modules 230 and/or 235) operating on the route planning system 200, a driver computing device 100, parking reservation system 300, and/or other computing devices may access, query, and/or write to various databases (e.g., database 240). In various embodiments, the route planning module 230 is configured to plan and/or optimize delivery routes. In various embodiments, the parking reservation module 235 is configured to request and/or manage parking reservations. In various embodiments, the parking reservation location database 240 may be configured to store information about locations such as street side parking places, parking lots, parking garages, loading docks and/or other parking areas where parking reservations may be available. The parking reservation location database 240 may also store other information related to available parking spaces and/or parking reservations such as times when parking spaces and or parking reservations tend to be or are expected to be available, the cost of a parking reservation for a given location and/or time, the procedure for claiming a parking reservation at a given location, delivery locations that have been identified as locations for which a parking reservation should be made in order to efficiently deliver an item to the location, preferred parking locations for a given location, preferred parking type for a particular driver or location, and/or other information related to parking spaces and/or parking reservations. As should be appreciated, various embodiments may combine the functionality of the modules 230, 235 and/or the database 240 or may substitute one or more modules 230, 235 and/or databases 240 for other methods to incorporate the functionality described herein with respect to the modules 230, 235 and database 240.

### Parking Reservation Location Database 240

In various embodiments, a parking reservation location database 240 may be maintained by the route planning system 200. Various modules 230, 235, a driver computing device 100, and/or a user (directly or indirectly) interfacing with the route planning system 200 may access, query, and/or write to the parking reservation location database 240. For example, the route planning module 230 or the parking reservation module 235 may access the parking reservation location database 240 to determine if any delivery locations associated with the items to be delivered on a given day have been identified as locations where a parking reservation may make the delivery of an item to the location more efficient. In another example, a driver computing device 100 may access the parking reservation location database 240 to determine if parking reservations located near a particular delivery location are available.

In various embodiments, a parking reservation location database 240 may be configured to store information about locations such as street side parking, parking lots, parking garages, and/or other parking areas, such as loading docks, etc., where parking reservations may be available. For example, a parking reservation database 240 may comprise all of the locations in a given geographic area for which a parking reservation may be requested. In various embodiments, a street side parking area, parking lot, parking garage, and/or other parking area may be identified via a parking location identifier. GPS or other location data associated with the various parking location identifiers may also be stored in the parking reservation location database 240. In some embodiments, the parking reservation location database 240 may store location information, such as an address, GPS location, parking type (e.g., compact parking space, non-compact parking space, space in a low clearance parking garage, street side parking, parking space that can be backed into, and/or the like), etc. associated with an individual parking spot identifier that identifies a particular parking place for which a parking reservation may be made. The parking reservation location database 240 may also store other information related to available parking reservations such as times when parking or parking reservations tend to be or are expected to be available, cost of a parking reservation for a given location, the procedure for claiming a parking reservation at a given location, delivery locations for which a parking reservation should be made in order to efficiently deliver an item to the delivery location and/or other information related to parking reservations. In some embodiments, the parking reservation location database 240 may also store historical parking data that may be used to predict when parking may be available (e.g., times of the day and/or days of the week when parking may be available without the use of a parking reservation or when parking may be available near locations where parking reservations are not available). In various embodiments, the parking reservation location database 240 may store information related to parking place preferences. For example, a driver may prefer a particular parking place or parking place type, a non-compact parking place may be needed for parking a delivery vehicle, a parking place in a garage with sufficient clearance for a delivery vehicle may be required, a driver may prefer a parking place that can be backed into, and/or the like.

In various embodiments, the information stored in the parking reservation location database 240 is updated regularly, periodically, continuously, and/or as needed. For example, the parking reservation system 300 may send updates for the parking reservation location database 240 that may be automatically or manually implemented weekly, monthly, or whenever a significant change in the information related to the parking reservation location database 240 is made. In another example, a user of the parking reservation system 200, a driver computing device 100, and/or another computing device in communication with the route planning system 200 may provide an update of one or more entries and/or one or more new entries to the parking reservation location database 240.

### Parking Reservation Module 235

The parking reservation module 235 may be configured to determine, based on information in the parking reservation location database 240, if a parking reservation may facilitate delivery of one or more items to one or more delivery locations. The parking reservation module 235 may be configured to request one or more parking reservations. In various embodiments, the parking reservation module 235 may be configured to receive one or more reservation confirmations, to provide parking reservation information to the route planning module 230, and/or to transmit reservation confirmation and/or reservation claim information to the driver computing device 100. In one embodiment, the parking reservation module 235 may be configured to determine when a parking spot at a particular location tends to be or is expected to be available. In various embodiments, the parking reservation module 235 is configured to determine if a parking reservation should be requested. In various embodiments, the parking reservation module 235 may receive a request to make one or more parking reservations from the route planning module 230, the driver computing device 100, user input, and/or some other method.

In various embodiments, the parking reservation module 235 may be configured to determine if a delivery location for an item to be delivered is listed or flagged in the parking reservation location database 240. In various embodiments, if a delivery location is listed or flagged in the parking reservation location database 240 a parking reservation may make the delivery of an item to the location more efficient. Therefore, in various embodiments, if a delivery location is listed or flagged in the parking reservation database 240, the parking reservation module 235 may request a parking reservation near the delivery location listed in the parking reservation location database 240. In some embodiments, the parking reservation module 235 may provide the route planning module 230 with a list of one or more delivery locations for one or more items to be delivered for which a parking reservation may facilitate the delivery of an item to the one or more delivery locations. In various embodiments, parking reservation module 235, or a module similar to the parking reservation module 235 operating on the driver computing device 100, may provide the route planning module 230 with parking reservation information to be incorporated into the planning and/or optimization of one or more delivery routes.

In various embodiments, the parking reservation module 235 may be configured to request one or more parking reservations. For example, the parking reservation module 235 may generate and transmit or otherwise communicate one or more parking reservation requests to a parking reservation system 300. In various embodiments, the parking reservation request may comprise a request for a parking reservation for a particular location. For example, a particular parking reservation request may include the address of the delivery location, an intersection, or other landmark. The parking reservation request may further include a threshold distance such that a parking reservation may be requested within a radius of the threshold distance from the indicated address of the delivery location, intersection, or other landmark. For example, a parking reservation request may indicate that a parking reservation is requested within a hundred yards, two hundred yards, a tenth of a mile, and/or the like from the indicated address of the delivery location, intersection, or other landmark. In another example, the parking reservation request may include a geographical area associated with the delivery location (e.g., a geofenced area, a particular block, a particular parking lot or garage, and/or the like). For example, a predefined geographical area around a location may be used in a situation where a parking place located at a reasonable distance from the delivery location is not a suitable parking location (e.g., parking fees are above a threshold value, a parking garage that does not have sufficient height clearance for a delivery vehicle, and/or the like).

In some embodiments, a parking reservation request may comprise a road side parking place, parking lot, parking garage, and/or other parking location identifier configured to identify a particular parking place, a set of parking places, a parking place type, one or more parking place preferences, and/or the like, and/or combinations thereof. In various embodiments, the parking reservation request may comprise a time, time range, and/or time range window for the parking reservation. For example, a parking reservation request may comprise a request for a particular parking reservation starting at 2:00 pm. In another example, a parking reservation request may request a particular parking reservation for 2:00 to 2:15 pm. In yet another example, a parking reservation request may comprise a request for a 20 minute parking reservation window sometime between 1:00 pm and 4:00 pm. In various embodiments, a parking reservation request may also comprise information configured for identifying the carrier. For example, the parking reservation request may comprise a parking reservation customer ID associated with the carrier, IP address associated with the carrier, email address associated with the carrier, or the like. In some embodiments, a parking reservation request may further comprise identifying information regarding the vehicle or operator for which the parking reservation is being requested. For example, the parking reservation may include a license plate number, vehicle ID, vehicle make and model, operator ID, and/or company affiliation (e.g., a UPS delivery vehicle or the like).

In various embodiments, the parking reservation module 235 may be configured to determine when a parking space near a particular location tends to be or is expected to be available. For example, based on historical data, the parking reservation module 235 may identify time windows on various days during which a parking space tends to be available or is likely to be available. For example, based on data collected last month, the parking reservation module 235 may determine that a parking space is usually open on Tuesdays between 1:00 and 2:00 pm near a particular delivery location address. The historical data may be collected based on observations by delivery vehicle drivers, satellite images, traffic patterns, and/or other source. The historical data may include data collected over the previous month, more than one previous month, several weeks, and/or the like. In various embodiments, the historical data may be stored in the parking reservation location database 240. In various embodiments, the parking reservation module 235 may be configured to calculate the probability that a parking space will be available during one or more time windows. If it is determined that the probability that a parking space will be available during a particular time window exceeds a probability threshold (e.g., the probability that a parking space will be available is greater than and/or approximately equal to 95%, 90%, 75%, 50%, or the like), the parking reservation module 235 may provide the relevant information to the route planning module 230 for use in planning one or more delivery routes and/or save the relevant information to the parking reservation location database 240. Thus, in various embodiments, the parking reservation module 235 may determine time windows during which a parking reservation may not be needed to efficiently deliver an item to a delivery location. Therefore, it may be possible to avoid making unnecessary parking reservations and/or to ensure efficient package delivery to delivery locations where no nearby parking reservations are available.

In various embodiments, the driver computing device 100 may be configured to run a module with functionality similar to that described herein with respect to the parking reservation module 235. In other embodiments, the driver computing device 100 may be configured to communicate with the route planning system 200 in such a manner that a delivery vehicle driver may make use of the functionality of the parking reservation module 235 operating on the route planning system 200 via the driver computing device 100. Thus, in various embodiments, the parking reservation module 235 may act as an intermediary between the driver computing device 100 and the parking reservation system 300. In other embodiments, the driver computing device 100 may communicate directly with the parking reservation system 300 and bypass the parking reservation module 235 operating on the route planning system 200.

### Route Planning Module 230

The route planning module 230 may be configured to plan and/or optimize a delivery route or a set of delivery routes based on the items to be delivered and/or picked up on a given day, and/or other relevant criteria. In some embodiments, the route planning module 230 may be configured to plan and/or optimize one or more delivery routes based at least in part on one or more parking reservations and/or the projected availability of parking spaces. For example, in various embodiments parking reservation information and/or projected parking availability may provide one or more constraints to the route planning module 230 in addition to any constraints associated with the information related to the items to be delivered and/or picked up and/or other constraints. In other embodiments, the route planning module 230 may be configured to plan and/or optimize one or more delivery routes based on one or more parking reservations via some other method.

A variety of route planning and/or optimizing protocols that may be used by the route planning module 230 to plan and/or optimize one or more delivery routes are known in the art of delivery vehicle and/or service provider dispatching. For example, U.S. Pat. No. 7,624,024, issued Apr. 18, 2005 describes dynamic routing processes that may be used in connection with the embodiments of the present invention. U.S. Pat. No. 7,624,024 is hereby incorporated by reference in its entirety. As should be understood, various embodiments of the present invention may be relevant to a variety of route planning and/or optimizing protocols.

In various embodiments, the route planning module 230 may be configured to perform static route planning and/or optimization, wherein one or more delivery routes are planned and/or optimized and communicated to the delivery vehicle drivers before the day's deliveries have begun. An example static route planning method wherein the route planning and/or optimization incorporates one or more parking reservations and/or the projected availability of parking spaces is illustrated in FIG. 4 and described in detail below herein.

In various embodiments, the route planning module may be configured to perform dynamic route planning and/or optimization, wherein one or more delivery routes may be updated and/or optimized one or more times as needed or requested after the day's deliveries or pick-ups have begun. An example dynamic route planning method wherein the route planning and/or optimization incorporates one or more parking reservations is illustrated in FIG. 5 and described in detail below herein. In various embodiments, the route planning module 230 may be configured to perform a combination of static route planning and dynamic route planning.

Reference will now be made to FIGS. 4 and 5, which provide flow charts of two different embodiments of the present invention. As noted above, FIG. 4 illustrates an embodiment in which one or more parking reservations are requested before the delivery vehicle starts the day's deliveries. Herein, this embodiment shall be referred to as “static route planning.” In various static route planning methods, parking reservations may be made for when parking is expected to be available at a given location. FIG. 5 illustrates an embodiment in which one or more parking reservations are requested after the delivery vehicle starts the day's deliveries. Herein, this embodiment shall be referred to as “dynamic route planning.” In various dynamic route planning methods, a parking reservation may be based on whether parking is currently available at the requested location. These two embodiments will be discussed in more detail below herein.

### Static Route Planning

Reference will now be made to FIG. 4. A route planning system 200 may receive various information regarding item deliveries to be made on a given day. The information may include a delivery address for each of the item deliveries, referred to herein as the delivery location and/or delivery stop. Based on data stored in the parking reservation location database 240, the parking reservation module 235, operating on the route planning system 200, may generate and transmit one or more parking reservation requests configured to facilitate one or more deliveries at step 402. The one or more parking reservation requests may be transmitted to the parking reservation system 300.

At step 404, the parking reservation module 235, operating on the route planning system 200, receives a reservation confirmation for at least one of the requested one or more parking reservations (e.g., from the parking reservation system 300). The reservation confirmation may confirm the parking reservation information. The parking reservation information may include a location for the parking reservation and a time and/or time range for the parking reservation. For example, the parking reservation information may comprise an address or GPS location for the roadside parking, parking lot, parking garage, or other parking location for which the parking reservation was made, a particular parking spot identifier, a description of the location of the parking reservation (e.g., the parking lot located at the northwest corner of the intersection of Spring St. and 14^{th} St. or the like), or a parking location identifier associated with a roadside parking place, parking lot, parking garage, or other parking area. In various embodiments, the parking reservation information may further comprise a cost for the parking reservation. In some embodiments, the reservation confirmation may further comprise an electronic token, machine-readable or human-readable code, or the like that may be used to claim the parking reservation and may be associated with the parking reservation information. For example, the reservation confirmation may comprise a one or two dimensional barcode, QR code, MaxiCode, an alphanumeric code, and/or password. This confirmation may be used to access the parking spot and/or claim the parking reservation.

At least a portion of the parking reservation information for each of the one or more parking reservations may be provided to the route planning module 230 at step 406. The portion of the parking reservation information provided may include the location of the parking reservation, the delivery location for which the parking reservation was made, the time and/or time range associated with the parking reservation, and/or other information that may be relevant to planning and/or optimizing a delivery route. At step 408, the route planning module 230 may plan and/or optimize the one or more delivery routes, taking into account the parking reservation information associated with each of the one or more parking reservations. For example, the parking reservation information for each of the one or more parking reservations may be used to provide one or more constraints for the route planning and/or optimizing protocol.

After the one or more delivery routes have been planned and/or optimized, the route planning system 200 may transmit each of the delivery routes to the driver computing device 100 associated with the delivery vehicle driver for each route at step 410. If a delivery vehicle driver's route includes one or more parking reservations, some or a portion of the parking reservation information for each parking reservation associated with the driver's route may be transmitted to the driver computing device 100 associated with the delivery vehicle driver at step 412. In various embodiments, the token, code or the like associated with the parking reservation may also be transmitted to the driver computing device 100 associated with the delivery vehicle driver to allow access to the reserved parking location.

The delivery vehicle driver may then complete the delivery route using the one or more parking reservations, at step 414. In completing the delivery route, the delivery vehicle driver may need to use the token, code, or the like associated with the parking reservation information to claim the one or more parking reservations, as dictated by the parking reservation system 300.

### Dynamic Route Planning

Reference will now be made to FIG. 5, which shows a method of dynamic route planning that incorporates a parking reservation. As noted above, in a dynamic route planning, a delivery vehicle driver may be in the process of completing a delivery route when the request for the parking reservation is transmitted to the parking reservation system 300. In various embodiments, the driver computing device 100 may operate a module with functionality similar to that described herein with respect to the parking reservation module 235. In other embodiments, the driver computing device 100 may be in communication with the route planning system 200 in such a manner as to use the functionality of the parking reservation module 235 operating on the route planning system 200.

In a variety of situations, a delivery vehicle driver may be in the process of completing a delivery route, at step 502, when the delivery vehicle driver realizes that it may be advantageous to request a parking reservation for one or more stops on the delivery route. For example, a driver may arrive to deliver an item and not be able to find an appropriate parking place. The driver may then request a parking reservation for later in the day and continue with the other stops on the delivery route. In another example, a delivery vehicle driver may receive a request to pick up a particular item at a time when the area around the delivery location is very busy and finding parking may be difficult. In various embodiments, the driver and/or the driver computing device 100 may query the parking reservation location database 240 to determine if parking reservations are available near the delivery location before submitting a parking reservation request. In some embodiments, the parking reservation module 235 may automatically initiate a parking reservation request without input from the driver computing device 100 while the delivery vehicle driver is in the process of completing a delivery route. For example, a request may be generated automatically when the vehicle is within a predetermined threshold distance or estimated delivery time of a particular delivery stop. In this instance, the parking reservation module 235 may send a notification to the driver computing device 100 that a reservation has been procured. In other embodiments, the driver computing device 100 may prompt the delivery vehicle driver to request a parking reservation for delivery of a particular item. The notification may be based at least in part on information stored in the parking reservation location database 240 and/or real-time information related to parking and/or traffic in area near the delivery location.

Thus, at step 504, the driver computing device 100 or the parking reservation module 235 operating on the route planning system 200 generates and/or transmits a parking reservation request to the parking reservation system 300. In some embodiments, the driver computing device 100 may, at least for some communications, communicate with the parking reservation system 300 through the route planning system 200, for example via the parking reservation module 235. In such an embodiment, the driver computing device 100 may generate and/or transmit the parking reservation request to the parking reservation module 235 which may then forward the request to the parking reservation system 300.

As noted above, a parking reservation request may comprise a location for the parking reservation, a time or time range for the parking reservation, and/or possibly other information. The parking reservation request may be based on the current location of the delivery vehicle, the time the driver expects to be in the vicinity of the delivery location near which the driver would like a parking reservation, or the amount of time it will take the delivery vehicle to travel to the delivery location near which the driver would like a parking reservation.

In response to the parking reservation request, the driver computing device 100 may receive information regarding the availability of one or more parking reservations, at step 506 from the parking reservation system 300. The information regarding the availability of a particular parking reservation may comprise one or more parking reservation options from which the delivery vehicle driver may select a particular parking reservation. The delivery vehicle driver may review the information about the available parking reservations and commit to a particular parking reservation at step 508. Committing to a particular parking reservation may comprise transmitting a parking reservation commitment to the parking reservation system 300 (possibly via the parking reservation module 235). The parking reservation commitment may comprise an indication of a selection of a particular parking reservation from the one or more parking reservation options.

The driver computing device 100 receives a parking reservation confirmation for the particular parking reservation and may transmit the parking reservation information to the route planning system 200, requesting an updated delivery route, at step 510. However, in embodiments where the driver computing device 100 communicates at least in part with the parking reservation system 300 through the parking reservation module 235 operating on the route planning system 200, the driver computing device 100 may not need to transmit the parking reservation information to and/or request an updated delivery route from the route planning module 230 operating on the route planning system 200. The route planning module 230 may then plan and/or optimize the remainder of the delivery route based on the parking reservation information and transmit the updated delivery route to the driver computing device 100. The delivery vehicle driver may then complete the updated delivery route using the parking reservation, at step 514.

As described herein, the route planning module 230 and the parking reservation module 235 may be separate modules operating on the route planning system 200. In various embodiments, the functionality of the modules 230 and/or 235 may be implemented via various methods other than those disclosed herein. For example, in some embodiments, the route planning module 230 may be responsible for receiving a parking reservation confirmation, which is described herein with regard to the parking reservation module 235. In another example, modules 230 and 235 may be combined into a single module and/or may operate on a computing system separate from and in communication with the route planning system 200. Additionally, as described herein, the parking reservation location database 240 may be a distinct database stored on the route planning system 200. However, in various embodiments, at least some of the information described herein as being stored in the parking reservation location database 240 may be stored in some other database or via some other method. In some embodiments, the parking reservation location database 240 may be divided into more than one database and/or may be fully or partially incorporated into another database. Thus, modules 230, 235 and the database 240 are described as separate modules and databases herein in order to describe various functions of the various embodiments, rather than to be limiting.

### Alternate Embodiments

As described above herein, the static and dynamic route planning methods are distinct methods of employing the present invention. However, in various embodiments, it may be advantageous to implement a combination of the static route planning and dynamic route planning methods described above. For example, a scheduled delivery may prompt the parking reservation module 235 to request a parking reservation before the day's deliveries have begun. After the day's deliveries have begun, a request for an item pick-up may be received and a parking reservation for use during the item pick-up may be requested via the driver computing device 100 or the parking reservation module 235. Thus, the static route planning and dynamic route planning methods described above may be used in cooperation to provide efficient delivery and pick-up services to customers.

### Route Planning Based on Projected Parking Availability

In various embodiments, the route planning module 230 may receive projected parking availability information that may be used as a constraint in planning one or more delivery routes. For example, it may be difficult to find legal and/or nearby parking near a particular delivery location but there may not be parking reservations in the vicinity of the particular deliver location. Thus, planning a delivery route around when parking is expected to be available may cause a stop of the particular delivery location to be more efficient. In another example, projected parking availability may be used to reduce the use of parking reservations. For example, parking may generally be available at a particular location between 10:00 and 11:00 am, but parking may not be generally available and a parking reservation may be required and/or recommended from 11:00 am to 5:00 pm. Thus, the route planning module 230 may attempt to plan any deliveries for the particular delivery location between 10 and 11 am. For a particular location, the project parking availability may indicate that the probability that parking will be available between 10:00 and 11:00 am is 95%, the probability that parking will be available between 11:00 am and 12:00 pm is 85%, and the probability that parking will be available between 12:00 pm and 1:00 pm is 50%. The route planning module 230 may use this projected parking availability to optimize one or more delivery routes. The projected parking availability information may be used in a variety of ways as a constraint, weighted constraint, and/or the like by a variety of route planning and optimization processes.

In various embodiments, the projected parking availability may be used as part of static route planning or dynamic route planning. For example, the projected parking availability information may be used to plan and/or optimize a delivery route before the delivery driver begins the day's deliveries. In another example, a route may be planned based on when a parking reservation is expected to be available near one or more delivery locations before the day's deliveries have begun. The parking reservation may then be requested while the delivery vehicle driver is in the process of completing a delivery route (e.g., when the vehicle is within a predetermined threshold distance or estimated delivery time of a particular delivery stop, and/or the like). The project parking availability information may then be used in subsequent route planning and optimization that occurs while the delivery vehicle driver is in the process of completing a delivery route. Some embodiments of the present invention may use only one of the projected parking availability and parking reservations to complete various route planning and/or optimization processes.

### Additional Example Embodiments

In various embodiments, parking reservations may be incorporated into dispatch plans for service providers other than item deliveries and pick-ups (e.g., delivery of pizza, flowers, or other items). Other service providers such as carpet cleaners, plumbers, mobile dog cleaning services, and/or the like may also find that incorporating parking reservations into dispatch planning is advantageous. These examples are intended to illustrate the broad spectrum of industries in which planning and/or optimizing dispatch plans based on parking reservations are applicable, not to be limiting.

As noted above, in various embodiments, a parking reservation may be made for a parking place to be used when delivering an item and/or making a service stop. In various embodiments, the reserved parking place may be a street side parking place, a parking place in a parking lot, a parking place in a parking garage, or some other parking place. In other embodiments, the parking reservation may be a reservation for use of a loading dock. A loading dock reservation may be particularly relevant for the delivery of freight shipments, especially less than truck load freight shipments or freight shipments to locations with a small number of loading docks. A loading dock reservation may also be relevant for moving trucks assisting in moving a customer into or out of an urban high-rise building which may only have one or two loading docks.

### CONCLUSION

In urban or metropolitan areas, or other areas where parking may be hard to find, planning and/or optimizing a delivery route or dispatch plan around one or more parking reservations and/or loading dock reservations may be used to increase the efficiency of providing services to customers in these areas. In various embodiments, the parking reservation may be made before the driver is dispatched to complete the day's route. In other embodiments, the driver may request a parking reservation during the course of completing the day's route. In still other embodiments, parking reservations may be requested before the driver is dispatched for the day and/or while the driver is in the process of completing the day's route. By requesting a parking reservation, efficiency will be increased by decreasing parking tickets received, decreasing time spent looking for parking, and/or decreasing the distance the driver needs to walk to complete the delivery, pick-up, and/or other service stop.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for facilitating selective parking reservations and providing plans to a plurality of vehicles based on the selective parking reservations, the system comprising:
a plurality of computing devices having corresponding processors and memories, the plurality of computing devices being associated with a plurality of vehicles;
a centralized route planning system having another processor and a memory, the centralized route planning system communicating with the plurality of computing devices, a parking reservation system, and a parking reservation database, and wherein the centralized route planning system, on a given day and for each vehicle in the plurality of vehicles:
automatically searches the parking reservation database to determine whether a plurality of locations for the given day is associated with a corresponding flag, wherein the flag indicates that requesting a parking reservation for the location is recommended on the given day;
electronically communicates a plurality of parking reservation requests to the parking reservation system for each of the plurality of locations that is associated with the corresponding flags based on the queries to the parking reservation database;
receives a plurality of confirmations from the parking reservation system in response to the plurality of parking reservation requests electronically communicated to the parking reservation system;
generates a dispatch plan that comprises a sequence of stops along a defined route for the vehicle, wherein the dispatch plan includes the plurality confirmations based on the plurality of parking reservation requests electronically communicated to the parking reservation system; and
electronically communicates the dispatch plan to a computing device of the vehicle, wherein the dispatch plan is configured for presentation by the computing device at the vehicle on the given day in advance of performance of the dispatch plan.

2. The system of claim 1, wherein the plurality of vehicles comprises five or more vehicles.

3. The system of claim 1, wherein the centralized route planning system is located remotely from the plurality of computing devices associated with the plurality of vehicles, the parking reservation system, and the parking reservation database.

4. The system of claim 1, wherein the centralized route planning system communicates wirelessly with the plurality of computing devices associated with the plurality of vehicles, the parking reservation system, and the parking reservation database.

5. The system of claim 1, wherein the parking reservation database stores a plurality of GPS locations that are associated with a plurality of individual parking location identifiers, and wherein each of the plurality of individual parking location identifiers identify one particular parking location.

6. The system of claim 1, wherein the plurality of parking reservation requests comprise, for each location of the plurality of locations that is associated with the corresponding flag, an individual parking location identifier that identifies a particular parking location.

7. The system of claim 6, wherein the individual parking location identifier is associated with GPS data that corresponds to the particular parking location.

8. The system of claim 7, wherein the dispatch plan, for each of the plurality of confirmations, comprises the GPS data that corresponds to the particular parking location for each of the individual parking location identifiers.

9. The system of claim 1, wherein each of the plurality of computing devices associated with the plurality of vehicles includes a Global Positioning System (GPS) module and a display.

10. The system of claim 1, wherein the plurality of locations includes one or more of a pickup address and a delivery address.

11. A system for facilitating selective parking reservations and providing dispatch plans to a plurality of delivery vehicles based on the selective parking reservations, the system comprising:
a plurality of driver computing devices corresponding processors and memories, the plurality of driver computing devices being associated with a plurality of delivery vehicles;
a centralized route planning system having a processor and a memory, the centralized route planning system communicating with the plurality of driver computing devices, a parking reservation system, and a parking reservation database, and wherein the centralized route planning system, on each given day for a plurality of days and for each delivery vehicle in the plurality of delivery vehicles:
automatically queries the parking reservation database to determine whether each of a plurality of delivery locations associated with items to be delivered on the given day is associated with a corresponding flag, wherein the flag indicates that requesting a parking reservation for the delivery location is recommended on the given day;
electronically communicates a plurality of parking reservation requests to the parking reservation system for each of the plurality of delivery locations that is associated with the corresponding flags based on the queries to the parking reservation database;
receives a plurality of confirmations from the parking reservation system in response to the plurality of parking reservation requests electronically communicated to the parking reservation system, wherein each of the plurality of the confirmations comprises an electronic token for claiming a corresponding parking reservation;
in response to receiving the plurality of confirmations, generates a dispatch plan that comprises a sequence of delivery stops along a defined route for the delivery vehicle, wherein the dispatch plan includes the plurality of confirmations; and
electronically communicates the dispatch plan to a driver computing device of the delivery vehicle, wherein the dispatch plan is configured for presentation by the driver computing device at the delivery vehicle on the given day in advance of performance of the dispatch plan.

12. The system of claim 11, wherein the parking reservation database stores a plurality of GPS locations that correspond to a plurality of individual parking location identifiers, and the plurality of individual parking location identifiers identify a plurality of particular parking locations.

13. The system of claim 12, wherein the dispatch plan comprises, for each of the plurality of confirmations, one of the plurality of GPS locations that corresponds to one of the plurality of individual parking location identifiers, and that identifies one of the plurality of particular parking locations.

14. The system of claim 13, wherein the dispatch plan comprises, for each of the plurality of confirmations, an electronic token for claiming the one of the plurality of particular parking locations on the given day.

15. The system of claim 11, wherein the sequence of delivery stops is determined based on the plurality of confirmations.

16. The system of claim 11, wherein the sequence of delivery stops is determined using a plurality of times during the given day that correspond to the plurality of confirmations.

17. The system of claim 11, wherein the sequence of delivery stops is determined using a plurality of times during the given day, wherein the plurality of times are specified in the plurality of confirmations, and wherein the plurality of times are determined by the parking reservation system based on predicted availability of a corresponding plurality of parking locations.

18. The system of claim 11, wherein the centralized route planning system, on each of the plurality of days, identifies the plurality of delivery locations associated with items to be delivered on the given day.

19. The system of claim 11, wherein the centralized route planning system, on each of the plurality of days, identifies a subset of the plurality of driver computing devices associated with the plurality of delivery vehicles that correspond to the items to be delivery on the given day.

20. A system for facilitating selective parking reservations and providing dispatch plans to a plurality of delivery vehicles based on the selective parking reservations, the system comprising:
a plurality of driver computing devices corresponding processors and memories, the plurality of driver computing devices being associated with a plurality of delivery vehicles;
a centralized route planning system comprising a processor, a memory, a route planning module, and a parking reservation module, the centralized route planning system configured to communicate with the plurality of driver computing devices, a parking reservation system, and a parking reservation database, wherein on each given day of a plurality of days and for each delivery vehicle in the plurality of delivery vehicles:
the route planning module automatically queries the parking reservation database to determine whether each of a plurality of delivery locations associated with items to be delivered on the given day is associated with a corresponding flag, wherein the flag indicates that requesting a parking reservation for the delivery location is recommended on the given day;
the parking reservation module electronically communicates a plurality of parking reservation requests to the parking reservation system for each of the plurality of delivery locations that is associated with the corresponding flags based on the queries to the parking reservation database;
the parking reservation module receives a plurality of confirmations from the parking reservation system in response to the plurality of parking reservation requests electronically communicated to the parking reservation system, wherein each of the plurality of the confirmations comprises an electronic token for claiming a corresponding parking reservation;
in response to receiving the plurality of confirmations, the route planning module generates a dispatch plan that comprises a sequence of delivery stops along a defined route for the delivery vehicle, wherein the dispatch plan includes the plurality of confirmations; and
the route planning module electronically communicates the dispatch plan to a driver computing device of the delivery vehicle, wherein the dispatch plan is configured for presentation by the driver computing device at the delivery vehicle on the given day in advance of performance of the dispatch plan.
